(19) United States
(12) Patent Application Publication
(10) Pub. No.: US 2001/0027403 A1
(43) Pub. Date: Oct. 4, 2001

(54) System and method for employing targeted messaging in connection with the submitting of an insurance claim

(76) Inventors: Robert B. Peterson, Indianapolis, IN (US); Todd J. Morris, Westfield, IN (US)

Correspondence Address: C. David Emhardt, Esq., Woodard, Emhardt, Naughton, Moriarty and McNett, Bank One Center/Tower, 111 Monument Circle, Suite 3700, Indianapolis, IN, 46204-5137, US

(21) Appl. No.: 09/742,782

(22) Filed: Dec. 20, 2000

Related U.S. Application Data
(63) Continuation-in-part of application No. 09/540,574, filed on Mar. 31, 2000.

(51) Int. Cl. G06F 17/60

(52) U.S. Cl. 705/4

(57) ABSTRACT

The present invention relates to a method for providing targeted information to an insured patient and/or to a health care provider based on information assembled and submitted at the time of the insured patient's visit to a health care provider. The targeted information is based on claim data which is inputted to a claim adjudication program through electronic data interchange (EDI) between the health care provider and a payer. The system and method of the present invention, delivers information, such as advertisements, coupons, informative medical information, etc., wherein this further information is selected for delivery to the insured and/or provider based upon information submitted. For example, if the submitted information indicates that the insurance claim is related to prenatal care for a pregnant woman, coupons for baby supplies (such as baby food, diapers, clothing, etc.) may be delivered. As a further example, a prescription drug compliance message for any drugs prescribed to the patient may be delivered. In this way, the information may be delivered promptly to those insureds and/or providers who likely have a need for the information.

This application is a continuation-in-part of U.S. Ser. No. 09/540,574 filed Mar. 31, 2000.

### TECHNICAL FIELD OF THE INVENTION

The present invention generally relates to systems and methods for data processing and, more particularly, to a system and method for employing targeted messaging with delivery of an explanation of benefits statement to an insured as well as to employing targeted messaging in connection with the submitting of an insurance claim on an electronic basis.

### BACKGROUND OF THE INVENTION

As is commonly known, many people purchase insurance in order to spread the risk of financial liability resulting from the occurrence of an event covered by the insurance policy. For example, it is very common for a person to carry medical insurance coverage, such that some or all expenses associated with the treatment of medical conditions experienced by that person will be borne by the insurance company. Such insurance coverage may be offered by insurance companies because, while the benefits paid by the insurance company for some of the insureds will greatly exceed the amounts paid by these insureds for their policies, the majority of the insureds will pay more for their policies than they will receive in benefits from the insurance company. In this way, the total group of insureds is spreading the risk for liability for the entire group's medical costs.

Whenever an insured desires to receive payment from the insurance company to cover some or all of the cost of a medical treatment, the insured is required to submit a claim to the insurance company. This claim is then evaluated by the insurance company, which then makes a determination as to whether the insurance company will provide a payment and, if so, how much of the total cost of the medical treatment the insurance company will pay for. For example, many insurance policies include deductibles which must be met by the insured before the insurance company begins to assume financial liability for medical treatment. Such deductibles can be on a per visit basis, a yearly basis, etc. After the deductible has been met by the particular insured, many policies still do not pay the total remaining cost of the medical treatment, but instead may provide payments on a cost-sharing basis with the insured. Other factors which may have a bearing upon the amount paid by the insurance company include per-occurrence maximums and lifetime maximums, both of which will cap the total liability of the insurance company. Because of these factors, claims submitted to an insurance company must go through a process known as claim adjudication. In the claim adjudication process, the insurance company evaluates all of the claim data submitted by the insured and makes a determination as to what benefits the insurance company is willing to pay to the insured. The results of the claim adjudication process are typically communicated to the insured by means of a printed explanation of benefits (EOB) statement.

The EOB typically summarizes the medical treatment that has been delivered to the patient by the provider and, for each service rendered, summarizes the applicability of the insured's insurance policy to that service. In other words, for each service detailed on the EOB, the insurance company indicates what portion of the total cost of the service is payable by the insurance company under the policy and what portion is payable by the insured (including denotation of any differences between the provider's charges and agreed-upon reimbursement rates). Insurance companies incur a substantial amount of cost in producing the EOB and mailing it to the insured. For example, expenses associated with receiving the claim data, inputting this data into the insurance company's computer (if necessary), adjudicating the claim, printing the EOB and mailing the EOB to both the insured and the healthcare provider, as well as the overhead costs allocatable to each of these functions, add up to a significant expense for the insurance company for each EOB prepared. Consequently, it would be desirable to find a way to reduce the cost of delivering the EOB to the patient and/or offset such cost.

It is becoming more common for medical insurance claims to be submitted electronically in a process known as EDI (electronic data interchange). Such EDI may occur through a closed network in which multiple parties are connected to send and receive transactions from one computer system to another through an intermediary that receives a fee per transaction. Alternatively, the parties may communicate directly with one another through an open network i.e. the public Internet, which requires an Internet service provider.

### SUMMARY OF THE INVENTION

When a medical service provider such as a physician is visited by a patient, the provider typically will obtain (or perhaps already has) a substantial amount of information about the patient and his sickness, symptoms and condition. In most cases it is necessary for the provider to submit much of this information to the insurance company. The instant or the time period during which this information is assembled and submitted to the payer is also the instant or time period that is most appropriate for targeted information relating to the submitted information to be delivered to the patient and/or physician. For example such targeted information might be drugs that are indicated for treating a particular symptom or illness, alternative insurance policies that might be desirable for the patient to purchase such as life insurance or long term care policies, or a money saving coupon that might be redeemed at a particular pharmacy toward the cost of a prescription.

One embodiment of the present invention might include a method for employing targeted messaging in connection with the delivery of an explanation of benefits to an insured patient being treated by a health care provider. The method includes providing a claim adjudication program and inputting claim data to the claim adjudication program through electronic data interchange (EDI) between the health care provider and a payer. The method further involves providing substantially immediately targeted messaging materials based on said claim data. A further step of the method is creating an explanation of benefits (EOB) based upon the claim data.

Another embodiment of the invention is a method for employing targeted information based upon information assembled and submitted at the time of an insured patient's visit to a health care provider. The method includes inputting claim data to a claim adjudication program through electronic data interchange (EDI) between the health care provider and a payer. The method further includes providing substantially immediately targeted messaging materials based upon the claim data.

### BRIEF DESCRIPTION OF THE DRAWINGS

FIG. 1 is a schematic process diagram of a prior art insurance claim submission, adjudication and payment system.

FIG. 2 is a schematic process diagram of a preferred embodiment insurance claim submission, adjudication and payment system of the present invention.

FIG. 3 is a schematic black diagram of a prior art batch insurance claim adjudication process.

FIG. 4 is a schematic block diagram of a prior art insurance claim adjudication process, which allows for both batch processing and realtime processing.

FIG. 5 is a schematic block diagram of a first embodiment insurance claim adjudication process of the present invention, which allows both batch and realtime adjudication.

FIG. 6 is a schematic block diagram of a second embodiment insurance claim adjudication process of the present invention, which allows both batch and realtime claim adjudication,

FIG. 7 is a schematic block diagram illustrating a mapping of responses function performed by the preferred embodiment system of the present invention.

FIG. 8 is a schematic block diagram of a preferred embodiment process for providing targeted information to an insured with delivery of an EOB.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

One embodiment of the present invention seeks to lower the cost of delivery of the EOB by recognizing that the EOB contains information that may be of value to third parties. In the field of marketing, it is considered highly desirable to be able to focus your marketing efforts upon those persons whom are most likely to need the goods and/or services being marketed. This is known as targeted marketing. By focusing the marketing efforts upon such individuals, not only does the success rate of such marketing dramatically increase, but the cost of the marketing in relation to the return also dramatically lowers.

The EOB contains specific, detailed information regarding the medical treatment that has been provided to the insured by the healthcare provider. For most courses of medical treatment, there is a wide array of goods and/or services that may be desirable to the patient due to the medical condition that is being treated. For example, if the patient is being treated for symptoms of asthma, there may be a number of prescriptions or over-the-counter medications that could be used to treat the condition but that are not being currently prescribed by the patient's healthcare provider. The manufacturer of one of these medications would therefore be very interested in providing information about the medication to the patient, knowing that the patient is a member of the class of persons who could benefit from the drug. The manufacturer of the drug would therefore be interested in including information with the EOB explaining the benefits of the drug, directing the patient to ask his or her healthcare provider about whether the drug could be beneficial to the patient, and also possibly including a coupon providing a discount for purchase of the drug. The ability to provide such manufacturers with direct exposure to people known to be in need of the class of products sold by the manufacturer can be very valuable.

Such messaging is most beneficial to the patient and most successful for the manufacturer if the patient is exposed to the messaging as soon as possible after delivery of the treatment. Unfortunately, the delay between receipt of treatment and receipt of the EOB using the known claim adjudication methods (as described in greater detail hereinbelow) is so great as to reduce the effectiveness of such messaging opportunities to almost zero. This problem can be illustrated by a look at the current insurance claim adjudication process.

Insurance companies and healthcare providers process more than 4.5 billion claims a year. Each claim costs providers (i.e. doctors, hospitals, etc.) an average of $8.00 for check-in, eligibility verification and billing. The cost of a typical claim is even higher for payer organizations (i.e. insurance companies)—an average of $11.00 per claim to re-price, adjudicate, and issue a check and an EOB. Claims processing costs for health maintenance organizations (HMOs) range from $8.00 to $11.50 per claim. Even at its most efficient, claims processing today is a multi-billion dollar industry. Furthermore, approximately 30% of all healthcare claims must be re-filed due to some kind of error, making them even more inconvenient. The result is that it takes an average of six weeks—and sometimes up to four months—to get a simple office visit claim resolved, and to get an EOB into the hands of the patient and the provider. After such a delay, the value of any targeted marketing associated with the EOB has been reduced to an almost negligible amount. The delay in receiving the EOB not only results in the patient often forgetting the particulars of the encounter with the doctor, but also a lost opportunity for the patient to use any information provided with the EOB shortly after the doctor's intervention.

For much of the messaging that could be done in association with the EOB, there is a public health benefit that could be realized with more timely delivery of the message. Many studies have shown, for example, that patients who receive a drug compliance message at the doctor's office are far more likely to use the drug as prescribed and for the recommended duration of therapy, which is highly associated with better health outcomes.

Recent technological innovations have provided some benefit to EOB processing. Today more and more claims in the United States are being processed electronically through electronic data interchange (EDI), which speeds the delivery of claims from provider to payer. Almost 65% of healthcare claims in the United States are now sent electronically, and many of those delivered by mail are scanned electronically using optical character recognition (OCR) to save data entry time.

But EDI and OCR are only partial solutions to a global problem: each addresses only a small fraction of the claims process that is completely inefficient. With rising administrative costs making it more and more difficult for payer organizations to stay competitive, the current claims adjudication process is placing an even greater strain upon the entire system.

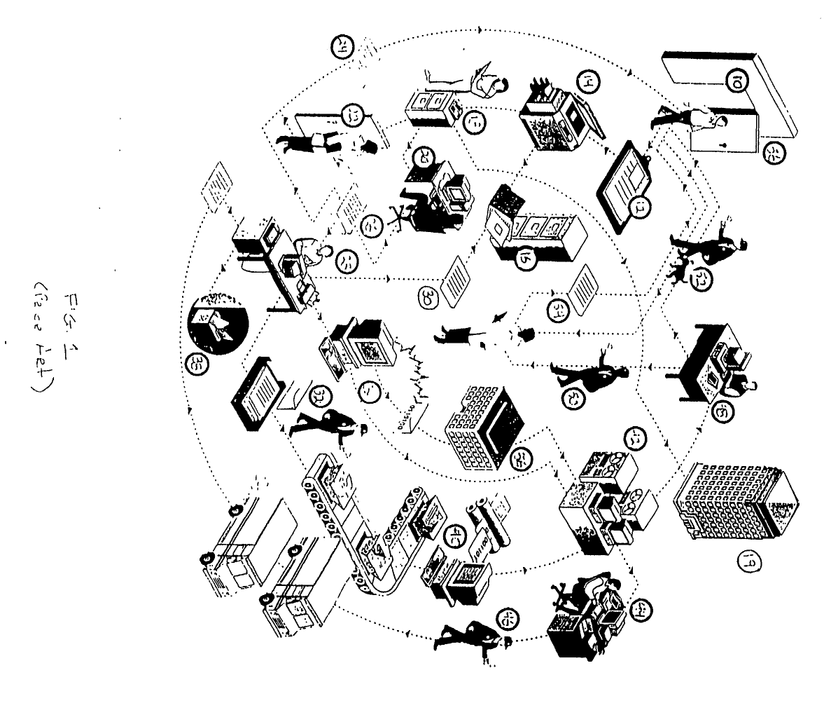

FIG. 1 schematically illustrates a typical prior art claim adjudication process for a fee-for-service insurance claim. Whether the claim is submitted on paper or electronically, the process is undeniably circuitous and confusing. The prior art process illustrated in FIG. 1 takes and average of six weeks to complete (much longer if there is any required re-filing due to errors, as occurs in 30% of the cases).

The process of FIG. 1 begins at step 10, where a patient needing care visits the healthcare provider. At 12, the patient checks in with the provider by presenting his insurance card and filling out a check-in form. At 14, the doctor's office staff copies the front and back of the patient's insurance card and files a photocopy of the card in the patient's record at 16.

At 18, the office staff calls the payer 19 on the phone to verify the eligibility of the patient. At 20, the office staff types the patient's information into a computer system located at the provider's office.

Only after the above processes have been completed does the patient get to see the provider 22. After treatment, the provider completes a super bill or charge ticket indicating diagnosis and treatment codes. One charge ticket copy (24) goes to the patient, while two copies (26) of the charge ticket go to the provider's billing office 28. One of these two copies (30) is retained in the patient's record. An insurance claim form is filled out manually and put into a stack 32 to be picked up and mailed to the payer 19. Alternatively, instead of being filed manually, the claim could be sent via EDI 34 directly to the payer 19, or through an electronic clearinghouse for editing and reformatting per specific payer guidelines, as is known in the art. If the claim presents problems, the office staff may set it aside at 38 to be addressed at a later time.

If the claim was submitted manually, the payer 19 will often transfer the manual claim to electronic files at 40 using optical character recognition (OCR). Once at the insurance company, the claims are batched, re-priced and adjudicated using large mainframe computers 42. Claims are usually spooled and run in large batch processes once per day in order to take advantage of the processing efficiencies of the mainframe computers 42. If the claim cannot be re-priced or auto-adjudicated using the mainframe computer 42, it is sent for personal review by a claims examiner 44. If the claims examiner 44 finds that the claim contains an error, it is returned to the healthcare provider's office staff for revision at 46.

If the claim is acceptable, it is then eligible for payment and is sent to the payer's accounting department at 48. A check (if necessary) and an explanation of benefits (EOB) is mailed to the provider at 50. A copy of the EOB is mailed to the patient at 52. At 54, the provider reconciles the EOB with the accounts receivable in his own records and re-bills the patient as necessary in order to collect any remaining unpaid balance. If there is a remaining balance for which the patient is responsible, the patient (hopefully) mails the provider a check at 56.

In order to maximize the value of any targeted messaging directed at the patient, the time for delivering such information is immediately after the patient has seen the healthcare provider. Under the current system as illustrated in FIG. 1, however, the patient is not provided with the EOB until weeks after the medical treatment. Because of this time delay, the value of the nexus between the treatment provided and the content of the targeted messaging has been severely reduced. Consequently, the value of the patient-specific information found on the EOB is not seen as being very high by companies that wish to market their products and/or services to the patient. In order to capitalize upon the inherent value of the information contained in the EOB, it is necessary to find a way to deliver the EOB into the hands of both the patient and the provider immediately after treatment. Not only does this guarantee that the patient is still in the market for the goods and/or services related to the medical treatment given to the patient, but the patient is also still in the presence of the doctor and has an opportunity to inquire about any of the information provided on the EOB. The present invention therefore utilizes a novel insurance claim adjudication system which allows immediate delivery of the EOB to the patient.

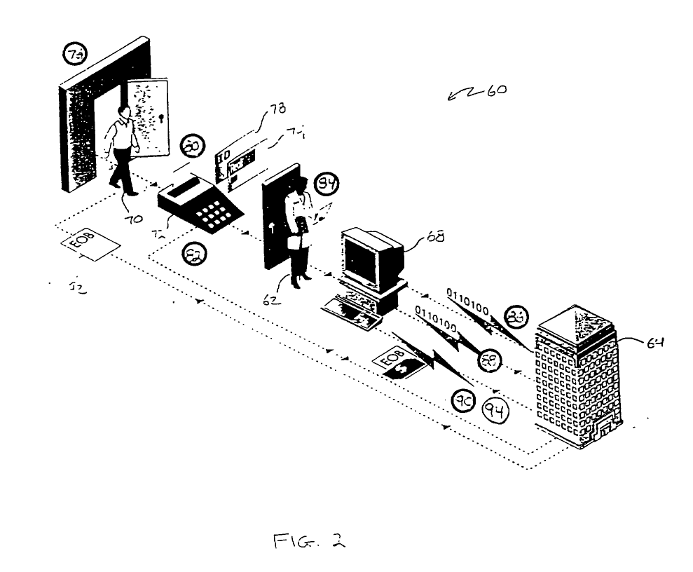

FIG. 2 schematically illustrates a preferred embodiment of the insurance claim adjudication system and process of the present invention, indicated generally at 60. In contrast to the confusing and circuitous prior art process illustrated in FIG. 1, the process 60 of the present invention is greatly streamlined.

At the heart of the system and process 60 is a realtime two-way communication link between the provider 62 and the payer 64. This communication link may take any convenient form, but is preferably provided as a thin-client application (e.g. a captive browser) on a global computer network, such as the Internet. The provider's office will therefore be equipped with a standard personal computer (PC) linked to the global computer network, through which the provider can access the claim submission, adjudication and payment system 68 of the present invention. Although it is contemplated by the present invention that the system 68 be provided and maintained by the payer 64, it is preferred that the system 68 be provided and maintained by a third party. This facilitates the use of the same system 68 to link the provider 62 with multiple payers 64, such that the system 68 may be used with most, if not all, of the provider's patients 70, regardless of which payer 64 carries the patient's insurance.

As a preferred option, a smart card reader 72 is coupled to system 68. This enables the patient 70 to present a smart card 74 upon visiting the provider 62, wherein the smart card 74 contains all of the data relating to the patient 70 and his insurance policy necessary to verify eligibility and to submit a claim, as detailed hereinbelow.

The process 60 of FIG. 2 begins at step 76, when the patient 70 requires medical care and visits the provider's office. In order to check-in with the provider 62, the patient 70 preferably submits his health insurance smart card 74 or other means of identification 78 at step 80. The provider's office staff accesses the claim submission, adjudication and payment system 68 of the present invention on the global computer network. If the smart card 74 has been presented, it is inserted into smart card reader 72 and all of the information required regarding the patient 70 and his insurance policy is read from the smart card 74. Because this information resides electronically on the smart card 74, the patient 70 may be checked in immediately even if the patient 70 has not previously been treated by this particular provider 62. If the patient 70 does not have a smart card 74 or has forgotten to bring it with him, the other identification card 78 may be used to access the patient's electronic file at the provider's office. If the patient 70 has not previously been to this provider's office, then it will be necessary to collect the necessary patient 70 demographic and insurance information so that a file may be set up.

At step 82, eligibility of the patient 70 is verified in realtime using the system of the present invention. The system connects directly to the records maintained by the payer 64, such that any applicable accumulators (lifetime limits, yearly deductibles, etc.) are live data. This is important to the eligibility determination at step 82 because it insures that the most up-to-date information regarding the patient's policy with the payer 64 is taken into account when making the eligibility determination. For example, if the patient 70 has an insurance policy that covers both himself and his wife and his wife attended a different doctor this morning and therefore met the policy deductible limit, this data will be known to the system of the present invention at step 82 when the eligibility determination for the patient 70 is made. The eligibility verification will therefore indicate that the patient 70 has met the required deductible for his insurance policy.

A significant advantage of the present system, therefore, is that the eligibility verification is completed at check-in using live accumulator data maintained by the payer 64. Because this occurs before the patient 70 sees the doctor 62, the patient 70 can be warned if he is expected to provide payment to meet a deductible, if his lifetime maximum for the projected treatment has been exceeded, etc.

After the eligibility verification at step 82, the patient 70 sees the provider 62 at step 84 for diagnosis and treatment. After treatment, the office staff uses the same system 68 used for eligibility verification to submit the patient's claim to the payer 64 at step 86. The system 68 incorporates online edits to provide a pre-check of the data entered onto the PC before the claim is submitted to the payer 64. For example, if the date of treatment entered into the claim submission form on the PC is mistakenly entered as a date after the current date, the system 68 of the present invention will warn the office staff that this must be corrected before the claim can be submitted at step 86. Furthermore, if any required fields have not been completed, the system 68 of the present invention will notify the office staff to correct these deficiencies prior to allowing the claim to be submitted to the payer 64. In this way, the system 68 of the present invention provides a first check on the claim submission information, looking for errors that would cause the claim to be rejected by the payer 64 and returned to the provider 62 for correction and resubmission.

Once the claim has been electronically submitted to the payer 64 at step 86, the claim information is processed by the payer 64 using their own claim adjudication logic to determine what amount, if any, the payer 64 will pay to the provider 62 in view of the claim. As described in greater detail hereinbelow, step 88 therefor links the system of the present invention with the payer's existing adjudication logic to re-price and adjudicate the claim, returning the claim to the provider's PC for acceptance within seconds. If an error is found, the office staff receives an online notice so that it may be corrected and resubmitted immediately.

An important feature of the system 68 of the present invention is its ability to re-map error responses from the payer's system. Specifically, when the payer 64 finds a problem with the data submitted in the claim, it generates an error message identifying what was found to be unacceptable about the claim data. The system 68 of the present invention receives an error response from the payer 64 system and re-maps that to a suggested action on the part of the provider 62 that would allow the claim to move forward. In order to do this, the system 68 of the present invention uses error classification and cross-mapping. First, errors are classified as either fixable or non-fixable. If the error is of a fixable variety, then a message is sent to the provider 62 instructing the provider 62 what needs to be done in order to increase the chance that the claim will be accepted by the payer 64. The system 68 accomplishes this by being preprogrammed with appropriate instructions to the provider 62 for each possible error response that can be received from the payer 64. These instructions are preferably developed with assistance from the payer 64.

If the error is of the non-fixable variety, then an explanation is provided to the provider 62 explaining why it is a non-fixable error. For example, a non-fixable error would include a male patient wherein the treatment provided is described as a hysterectomy. In many cases, fixing the claim error requires obtaining more information from the patient 70. Because the error feedback is given to the provider 62 in realtime (i.e. while the patient 70 is still at the office), the additionally required information can be obtained from the patient 70, added to the claim and the claim can be successfully resubmitted.

When resubmitting claims, the system 68 of the present invention includes a significant fraud prevention feature. Every claim submitted to the payer 64 by the system 68 of the present invention receives a claim number from the payer 64. This claim number is attached to the electronic data file kept by the system 68 of the present invention relating to this claim. Every time the claim is edited by the provider 62 and resubmitted to the payer 64, this same claim number is used with the resubmitted claim data. This insures that the provider 62 is not accidentally paid twice for the same treatment if the same claim data is resubmitted to the payer 64. Conversely, if the provider 62 cancels the claim submission transaction in the system 68 of the present invention, the system 68 notifies the payer 64 to cancel the associated claim number.

An optional feature of the present invention is the ability for the system 68 to connect a claim examiner at the payer 64 with the provider's office in order to resolve a problem with a submitted claim. Such connection could take any convenient form, such as a message to the claim examiner to call the provider's office, a message to the provider 62 to call the claim examiner, a live chat session via the global computer network, Internet telephony including the provider 62, the claim examiner and possibly the patient 70. Once again, the intent in this situation is to resolve any deficiencies in the claim data or to supply any additionally required information in realtime while the patient 70 is still at the provider's office.

Once the claim has been successfully adjudicated, an EOB is electronically transmitted to the provider's office at step 90. A copy of the EOB is also printed out and provided to the patient at 92. Because the EOB is provided to the patient 70 while still at the provider's office, the patient 70 has the opportunity to review the EOB and dispute the accuracy of any information contained thereon. Furthermore, the provider 62 has the ability to collect any remaining balance due from the patient 70 while the patient 70 is still at the provider's office. This can significantly reduce the expense incurred by the provider in billing for services. But most significantly, the EOB is provided to both the provider and the patient while the patient 70 is still at the provider's office. The EOB may therefore also include targeted messaging material chosen based upon the data contained in the EOB, and this messaging information is provided to both the patient and the doctor precisely at the time that it will have its greatest impact.

Step 94 of the process 60 provides payment from the payer 64 to the provider 62 via the automated clearinghouse (ACH) of the banking system. Payment to the provider 62 can be accomplished in several methods. For example, the payer 64 can continue to pay the provider 62 by means of their current method, whether this might be a check mailed to the provider 62, an electronic funds transfer (EFT) directly to the provider's bank account, etc. In this case, the system 68 can advise the provider 62 as to when he should expect to be paid from the payer 64 at the time that the EOB is transmitted to the provider 62. In this case, the payer 64 will apprise the system 68 of their payment turn-around time guarantee and this information will be relayed to the provider 62. Optionally, the system 68 can effect a bank transfer to the provider 62 on behalf of the payer 64. A further optional feature of the system 68 is that the payer 64 may provide remittance information to the system 68 when payment is made to each provider 62. This allows the system 68 to keep track of remittances that have been paid and those that are still outstanding. The provider 62 is therefore able to use a utility function on the system 68 in order to generate a list of what claims have been paid and what claims have not yet been paid.

In order to provide realtime resolution of claims as illustrated in the process 60 of FIG. 2, it is necessary that the system 68 of the present invention be able to communicate in realtime directly with the claim adjudication processes employed by the payer 64. There are at least two ways to accomplish this (although additional ways are comprehended by the present invention), depending upon the systems already in place at the payer 64. Most payers use a batch process for adjudicating claims; however, many payers 64 also have a separate realtime input into the claims adjudication processing system which may be used by claims examiners that adjudicate claims which were rejected by the automated system for some reason. Because the payer 64 already has the provision for realtime access to its claim adjudication process in this instance, then the system 68 of the present invention can use an equivalent input into the payer 64 system in order to receive a realtime answer from the payer 64 on the adjudication of the claim.

If such a realtime input to the claim adjudication logic of the payer 64 is not available, then the present invention contemplates the modification of the payer 64 non-realtime batch system in order to allow a realtime claim adjudication response to be given to the provider 62. Payers 64 in this category normally generate electronic claim data (either received directly from the provider 62 or generated via data entry or an OCR process) that are assembled into large batches and then processed using a batch process running upon their internal systems (i.e. mainframe computer systems, mini-computers, desktop computers, etc.).

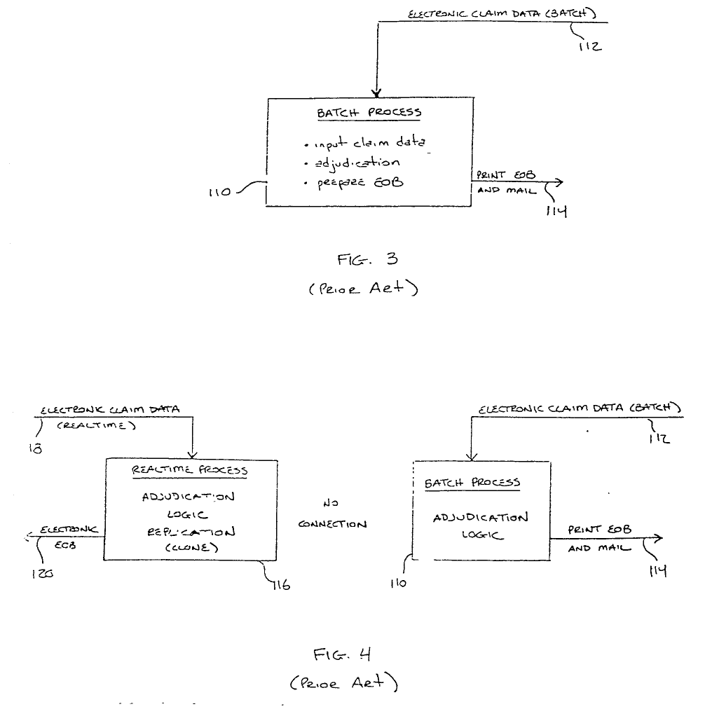

A schematic diagram of such a prior art batch process is illustrated in FIG. 3 and indicated generally at 110. The assembled electronic claim data 112 is typically input into the batch process 110 on a nightly basis. The batch process 110 comprises program modules written in development languages (such as C, COBOL, BASIC, etc.) which are operative to input the electronic claim data, adjudicate the claim according to particular rules developed by the insurance company and programmed into the batch process 110 software, and then prepare an EOB. EOB data is output at 114 and routed to a printer which will print the physical EOB that is then mailed to the required party (e.g. both the provider and the insured). The EOB will provide details as to which of the medical treatments performed are covered by the insurance policy and how much of the cost of each medical treatment will be paid by the insurance company. The payer then provides payment to the provider by separate means.

As detailed hereinabove, there are several problems with this prior art batch process 110 that does not provide realtime claim adjudication. The greatest problem, and the problem from which most of the other problems stem, is the extraordinary delay that occurs between the time that the insured receives medical treatment and the time that the provider and the insured receive the EOB. Delays are introduced into this process from a number of sources, including delays caused by the required data entry of the manually submitted claim information, errors and incompleteness in the submitted claim data that must be corrected (often necessitating a need for the doctor to resubmit the claim data), the fact that claim data is batched together when it is received and run at a later time, and the fact that the EOB is printed and mailed to the recipients. All of these delays add up to a total delay in providing the EOB to the patient and to the provider that makes targeted messaging based upon the information contained in the EOB nearly impossible.

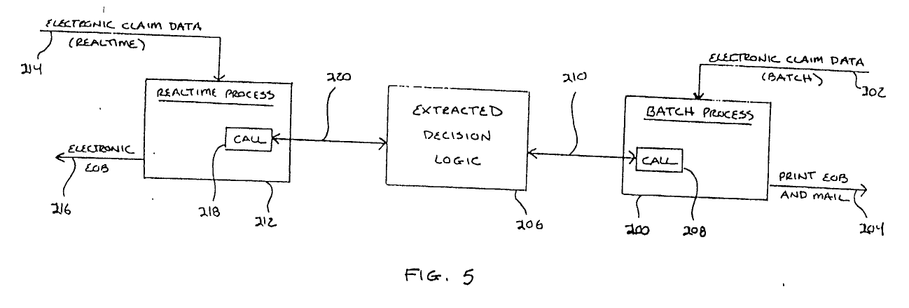

It is generally believed that the sooner the EOB can be delivered to the patient after delivery of the medical treatment, the fewer customer service calls that will be received from the insured, due to the details of the medical treatment still being fresh in the insured's mind. Consequently, there have been attempts in the prior art to provide realtime claim adjudication, as illustrated in FIG. 4. In order to implement realtime claim adjudication, the claim data must be transmitted directly from the provider's office in electronic form. However, this electronic data cannot be simply input into the payer's batch process 110 in realtime. This is because the batch process 110 is only executed on a nightly basis and the EOB is then printed and mailed. Obviously, this will not result in realtime claim adjudication, providing an EOB to the provider's office while the patient is still present.

Therefore, as illustrated in FIG. 4, it has been proposed in the prior art that a separate realtime process 116 be established, in which the adjudication logic utilized by the batch process 110 is replicated (cloned), typically upon a separate computer (and also typically not located at the payer). Realtime electronic claim data 118 generated by the provider's office is then electronically transmitted to the realtime process 116. The realtime process 116 applies the same claim adjudication logic utilized by the batch process 110 in order to determine whether the payer will make a payment based upon the claim, and if so, how much the payment will be. Rather than printing and mailing an EOB, the realtime process 110 instead electronically transmits the EOB information 120 back to the provider's office. A single computer at the provider's office can be used to enter and transmit the electronic claim data 118 and to receive and display the electronic EOB 120. In this manner, both the provider and the patient can receive the EOB from the payer while the patient is still at the provider's office. If either the provider or the patient believe that the EOB is incorrect, the matter can be resolved immediately while all parties are present and have access to any required information at the provider's office. Furthermore, because the provider knows how much the payer is willing to pay for the medical treatment, the provider may, at his option, collect the remaining amount directly from the insured while the insured is at the provider's office, rather than invoicing the insured. This saves the provider the expenses associated with invoicing and collecting this portion of the bill for treatment.

As illustrated in FIG. 4, there is no connection between the batch process 110 and the realtime process 116. Instead, the realtime process 116 contains a replication of the adjudication logic utilized in the batch process 110. The problem with this solution is that insurance companies are typically unwilling to give up control of the logic used in their claim adjudication process. Furthermore, even if the payer is willing to allow a replication of the adjudication logic to be made, further difficulties are encountered in that there are now two copies of this adjudication logic which need to be maintained and updated together. Failure to update one of the adjudication logic copies when the other is updated will result in the adjudication logic in each process diverging from one another, thereby producing different results depending upon which process is used to adjudicate the claim. For example, the adjudication logic must use data, such as accumulators, to adjudicate the claim. There will by necessity always be an incremental time lag between updating one database and updating the other database. For example, a patient may see his primary care physician and then walk across the hall to see a specialist. If the primary care physician submits his claim using the batch process and the specialist uses the realtime process, accumulator data accessed by the two systems may not accurate. Because of these problems, realtime claim adjudication using the system of FIG. 4 has never been accomplished.

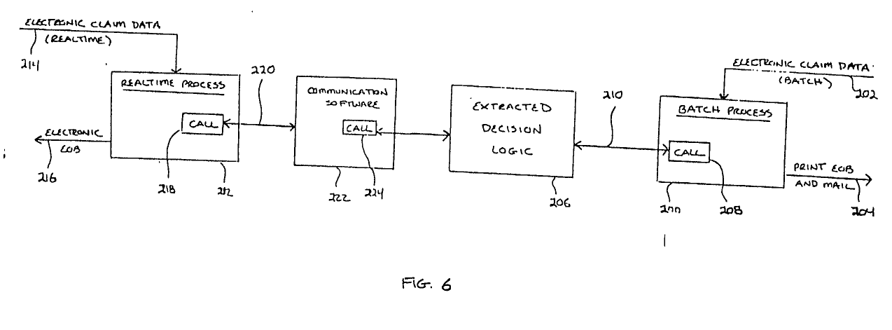

A first embodiment payer batch process integration system of the present invention is illustrated schematically in FIG. 5, in which a batch insurance claim adjudication process 200 runs on the insurance company's internal system. As with the prior art process 110, electronic claim data 202 is assembled for the batch process 200 from electronically submitted claim information (EDI) and from manually submitted claim information that has been converted to electronic data (e.g. by data entry, OCR, etc.). The electronic claim data 202 is accumulated until the batch process 200 is executed, typically once each evening. As with the prior art batch process 110, the batch process 200 of the first embodiment inputs the claim data 202, adjudicates the insurance claim according to predetermined adjudication rules logic and prepares an EOB which is printed and mailed at 204; however, the batch process 200 differs from the prior art batch process 110 in that the decision logic which adjudicates the claim has been extracted from the batch process software 200 and instead is segregated as the extracted decision logic 206. Typically, the extracted decision logic 206 will also reside on the company's internal system that runs the batch process 200. In a preferred embodiment, the extracted decision logic comprises the rules used by the insurance company to adjudicate an insurance claim and is encoded in COBOL in a CICS environment. Because the extracted decision logic 206 is formed as a CICS transaction (i.e. a single COBOL function) it can be executed with a function call. The batch process 200 includes a function call 208 at the appropriate place in the process to invoke the extracted decision logic 206. Because the batch process 200 and the extracted decision logic 206 typically reside on the same computer, the communication link 210 between the batch process 200 and the extracted decision logic 206 would typically be inside that computer; however, it will be appreciated by those having ordinary skill in the art that there is no technical reason why the batch process 200 and the extracted decision logic 206 cannot be located on separate computing devices, even computing devices which are physically remote from one another.

The system of FIG. 5 also allows for realtime claim adjudication by means of the realtime process 212. Electronic claim data 214 is submitted to the realtime process 212 in realtime and is adjudicated as it is received (i.e. there is no spooling of data waiting for a batch process to be executed). After the realtime process 212 has executed, an electronic EOB 216 is transmitted back to the provider's office, typically on the same communication line used to input the electronic claim data 214. For example, the interface between the provider's office and the realtime process 212 may be preferably provided as a thin client application (e.g. a web browser) running on a global computer network. When executing the realtime process 212, a function call 218 to the extracted decision logic 206 is made at the appropriate point in the process at which the claim adjudication rules need to be applied to the electronic claim data 214. In the preferred embodiment, the realtime process 212 executes on a separate computer from the one used to house the batch process 200 and the extracted decision logic 206. Therefore, the communication line 220 between the realtime process 212 and the extracted decision logic 206 preferably comprises a frame relay; however, those having ordinary skill in the art will recognize any communication means may be used for the connection 220 such as a dial-up modem. Furthermore, it is also possible that the realtime process 212, the extracted decision logic 206 and the batch process 200 all reside on the same computer system, whereby the communication lines 210 and 220 would be internal to such computer system. In the preferred embodiment, the frame relay 220 is maintained continuously (i.e. twenty-four hours per day).

In view of the foregoing, it will be appreciated that use of the same extracted decision logic by both the batch process 200 and the realtime process 212 has several advantages. For example, because the decision logic used for insurance claims adjudication is located at only one place, there is no problem with maintaining multiple versions and the concern that the multiple versions will diverge from one another due to problems with maintaining consistent updates. Furthermore, if the batch process 200 is run by the insurance company and the realtime process 212 is run by an independent contractor, the insurance company may feel more comfortable with retaining physical control over the extracted decision logic rather than allowing it to be replicated on another system. Because the extracted decision logic 206 is in the form of a CICS transaction, it can be executed (i.e. called) multiple times at the same instant without conflict. This allows the realtime process 212 to call the extracted decision logic 206 at the same time the batch process 200 is doing so, without fear of conflict. By using the system illustrated in FIG. 5, the payer is able to provide realtime processing of claim data for those clients which are set up with the proper hardware and software to access this function, while still being able to use the traditional batch process 200 for those clients which are not so enabled.

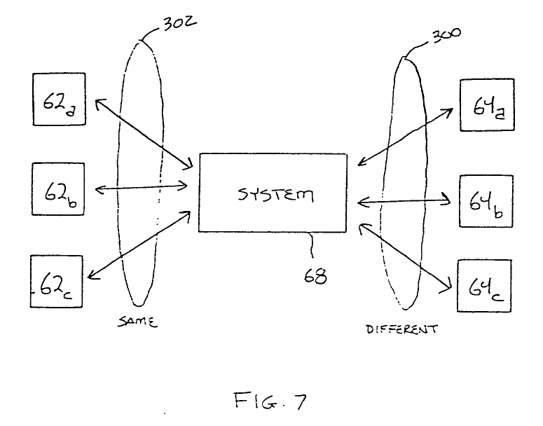

Referring now to FIG. 6, there is illustrated a second embodiment batch process integration system of the present invention. The system of FIG. 6 is substantially identical to the system of FIG. 5, with the exception that the function call 218 executed by the realtime process 212 does not communicate directly with the extracted decision logic 206. Instead, the function call 218 accesses an intermediate communication software module 222. In the embodiment of FIG. 6, the communication software 222, extracted decision logic 206 and batch process 200 all preferably reside upon the internal system at the insurance company, although this is not necessary. The communication software 222 receives the function call 218 across the frame relay 220 and in turn executes its own function call 224 to the extracted decision logic 206. Because the extracted decision logic 206 is also used with the batch process 200, the output of the extracted decision logic 206 in the embodiment of FIG. 6 is a print file containing all of the information necessary to be output on the line 204 to cause an EOB to be printed by a printer attached to the line 204. This print file is received by the communication software 222, which in turn strips off all of the printer formatting codes from this print file. The remaining data is then transmitted over the frame relay 220 back to the real time process 212 as a screen display (i.e. a block of data). This information is displayed on a screen coupled to the computer running the realtime process 212 and a screen-scraper software program is used to remove the data therefrom (because screen-scraper technology is well-known in the art, the details of this process are not given here). Once the realtime process 212 has obtained the claim adjudication data from the screen-scraper software, it is formatted in the desired format for an EOB and transmitted to the provider's office via the line 216.

It will be appreciated that the communication software 222 and the screen-scraping function would not be necessary in the process of FIG. 6 if the realtime process 212 were connected to the extracted decision logic using an FTP port. In this case, the print file produced by the extracted decision logic 206 could simply be transmitted directly to the realtime process 212 using the FTP port. However, in applications where (for financial reasons or otherwise) it is desired to use the frame relay 220 or other simple telecommunications line, the communication software may be inserted into the system in order to strip the printer formatting codes from the print file produced by the extracted decision logic 206 before transmitting this information over the frame relay 220. Furthermore, the extracted decision logic 206 could be reprogrammed to produce an output that is not in the form of a print file; however, assembling the print file based upon the data produced by the extracted decision logic 206 would then have to be shifted to the batch process 200 software for eventual output on the line 204.

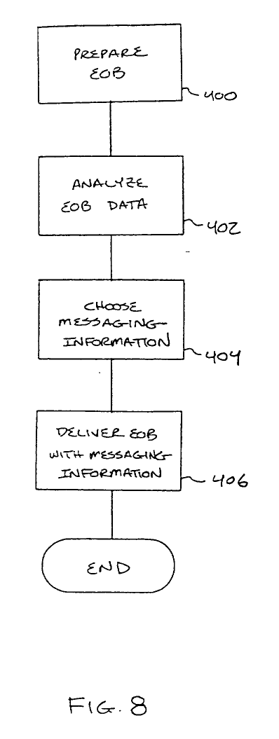

Another problem solved by the present invention relates to the fact that each of the four sections of the process 60 of the present invention (i.e. eligibility verification, claim adjudication, explanation of benefits, provision of payment to the provider) involves messages which must be transmitted from the provider 62 to the payer 64 and from the payer 64 to the provider 62. As illustrated in FIG. 7, the system 68 of the present invention will typically form a link between a plurality of providers 62a-c and a plurality of payers 64a-c. Because of a lack of standardization in the insurance industry, each of the payers 64a-c will require claim information to be submitted to them in a different form, and each of these payers 64a-c will communicate to the provider using different language. For example, each of the payers 64a-c may use different error messages in response to the same error condition. The communications 300 between the system 68 and each of the payers 64a-c will therefore be different for each line of communication.

On the other hand, it is desirable from the standpoint of the provider 62 that all of the communications 302 received from the system 68 of the present invention be uniform regardless of which payer 64a-c is adjudicating the claim. This means that the provider would like to submit the same information for every claim and receive the same information in response to the claim for each type of message transmitted from the payer 64. Such uniformity in the messages 302 makes it much easier for the provider 62 to interface with the system 68.

A feature of the system 68 is therefore a mapping of responses which allows the providers 62a-c to communicate in a uniform manner with the system 68 regardless of the particular payer 64, while the system 68 is able to communicate with each of the payers 64a-c in the format desired by each particular payer. For example, each of the payers 64a-c may have their own unique error message when a claim is submitted on behalf of a patient 70 for a medical treatment that is not covered by the patient's insurance policy. The system 68, on the other hand, will have a single error message to transmit to the provider 62 in response to the receipt of any of these various error messages from the various payers 64a-c. The system 68 therefore maps multiple, non-uniform error responses received from the various payers 64a-c onto a single, uniform error response that is transmitted to the provider 62.

In the opposite direction, the system 68 allows each provider 62 to input claim data in an identical format regardless of the payer 64 covering the particular patient 70, while the system 68 maps this data into an input format required by the particular payer 64a-c. In this way, the system 68 provides a single system which may be used by the provider 62 in a uniform manner, wherein the system 68 may be connected to a multiplicity of different payers 64, each having different requirements for the claim adjudication process. As new payers are added to the system 68, the only change noticed by the provider 62 is that he may use the system 68 for a greater percentage of his patients 70. There is no need on the part of provider 62 to learn yet another claim submission format for the newly added payer 64.

In view of the foregoing, it can be seen that the present invention provides a method for delivering an EOB into the hands of both the patient and the provider while the patient is still at the provider's office. This therefore provides an opportunity for including further information (such as targeted messaging materials) with the EOB in order to provide valuable information to the patient (or to the provider).

A preferred embodiment method of the present invention for including further information with delivery of the EOB is illustrated in FIG. 8. At step 400, the EOB is prepared in the manner discussed hereinabove. Prior to finalization of the EOB and delivery to the patient and provider, the data contained within the EOB relating to the provision of healthcare services to the patient is analyzed at 402. For each company wishing to provide targeted messaging with the EOB, predetermined criteria will be established for selecting which EOB is chosen for inclusion of the targeted messaging materials. For example, manufacturers of items such as baby food, diapers, baby clothing, etc. may wish to provide information concerning their products and/or coupons for their products in the EOBs delivered to women that have just received some sort of prenatal care. Also, if a company manufactures a drug that is used to treat a specific medical condition, the company may wish to provide information and/or coupons about these drugs with the EOBs of patients that are being treated for the condition for which the drug is useful. For prescription medications, the information may instruct the patient to ask the healthcare provider if the drug would be beneficial to treat the patient's condition. Furthermore, because a copy of the EOB is also delivered to the healthcare provider, such information can be beneficial to educate the provider as to the benefits of a particular medication.

As a further example, if the EOB data indicates that the patient has just received an eye examination, information and/or coupons relating to manufacturers who produce eyeglass frames, eyeglass lenses, contact lenses, contact lens cleaning solutions, etc. may be chosen for inclusion with the EOB. Similarly, if the EOB data indicates that the patient has just received a dental examination, then information and/or coupons relating to tooth-cleaning devices and preparations may be chosen for inclusion with the EOB.

Step 404 therefore chooses the appropriate messaging information based upon the application of the predetermined criteria to the data contained within the EOB. It is comprehended that messaging information from more than one company may be chosen for inclusion with the EOB if the predetermined criteria selected by both companies has been met by the EOB data. At step 406, the combined EOB and messaging information is delivered to both the patient and the provider. It should be stressed that it is not necessary for the messaging information to be on the same page as the EOB. Instead, the messaging information may be on a separate sheet(s) delivered with the EOB.

Although direct advertisements for products and/or services, as well as coupons for those products and/or services can be a very effective marketing tool, the present invention also contemplates the provision of general information, such as factual medical information (preferably related to the patient's treatment, although this is not necessary) to educate the patient and/or the provider. With the provision of such general information, it can be indicated that the information is “sponsored” by a particular company or organization. The name of the company or organization is therefore put before both the patient and the provider, and the company or organization will most likely be viewed in a favorable light in view of the service being provided in educating the patient and/or the provider.

As a further example, a specific pharmacy may wish to advertise its services and/or provide a money-saving coupon when the EOB indicates that the patient has been prescribed a drug as part of the treatment. Furthermore, it is contemplated by the present invention that the insurance company can also include targeted messaging materials in response to the EOB data. For example, the insurance company can market other insurance policies that it carries to the patient, such as life insurance policies, long-term care insurance policies, etc. Or, the data included in the EOB may indicate that a different medical insurance policy carried by the same insurance company may be more appropriate for the patient. Information on these products can be provided to the patient with delivery of the EOB.

It will be appreciated that the delivery of messaging information with the EOB as soon as possible after receipt of the medical treatment provides an excellent opportunity for the targeted marketing of goods and/or services to individuals who are known to be in the market for these goods and/or services. Perhaps most importantly, the targeted marketing for these goods and/or services is provided to the patient precisely at the time that they may be in need of these items and precisely at the time that they are contemplating the purchase of these items. The opportunity to influence the patient's consumer behavior is thus at a maximum. Being able to provide exposure to the patient at this time is therefore seen as a very valuable service by marketing entities. Revenue received from the marketing entities for the provision of these services can greatly offset the cost of providing the EOB or, in some instances, turn the provision of the EOB into a profitable activity.

It is important to recognize that, with the system and method of the present invention, the EOB data is never provided to the third party entity that wishes to provide messaging to the patient. Instead, the third party entity provides predetermined criteria for identifying individuals to which they would like to provide certain information. This information is provided to the individuals meeting this predetermined criteria during the claim adjudication process without ever divulging any confidential medical information (or even the identity of the recipients of the information) outside of the organization responsible for preparing and delivering the EOB. In this way, the confidentiality of the medical treatment data being analyzed is never compromised during the process of choosing what targeted information should be provided to the patient.

As explained above in connection with FIG. 1 the typical prior art claim adjudication process for a fee-for-service claim is circuitous and confusing. Thus, the prior art process illustrated in FIG. 1 takes an average of six weeks to complete and may require longer if there is any required re-filing due to errors. In many cases the claim information is submitted electronically in a process referred to as electronic data interchange (EDI). Such claim information may be transmitted electronically through a closed network in which there is an intermediary i.e. an electronic clearinghouse that receives a fee for each transaction. Alternatively, the claim information may be transmitted to the payer through the public Internet. This Internet transmission may occur through an intermediary i.e. an electronic clearinghouse that receives a fee or it may occur directly through the Internet to the payer.

The electronic clearinghouse earns the fee it receives by editing and reformatting the information it receives from the provider according to specific payer guidelines. In order to maximize the value of any targeted messaging directed at the patient or directed at the provider, the best time to deliver that information is when the patient sees the provider, not weeks or months later. As described above the delivering of an EOB to the patient at the time of the patient's visit to the provider makes possible delivering the targeted information to the patient and/or provider at the time of the office visit.

It may not be possible, however, to arrange a scenario in which the insurance company permits the claim adjudication program to be accessed on a real time basis so that the EOB is provided to the patient at the time of his visit to the physician. Thus one embodiment of the present invention involves providing the targeted information on a realtime basis and based on the information that is submitted to the payer at the time of the patient's visit to the physician whether or not that information is used to immediately provide an EOB and whether or not the claim adjudication occurs immediately. For example the claim adjudication may occur on a batch basis yet the targeted information is still provided during the patient's visit to the provider based on the claim information submitted to the payer by EDI during the patient's visit to the provider. Such providing of targeted information may be done by the electronic clearinghouse. Alternatively it may be done by the payer. However, in each case it is provided promptly by EDI during the patient's visit to the provider.

EDI may not occur while the patient is at the provider's office. Data relating to the treatment must be keyed into the computer and submitted. This keying in and submission may not occur until after the patient his left the provider's office. Most physicians presently are in the habit of making notes in pencil or pen or a chart. Thus the transferring of such information tot he computer from the chart does not occur in most cases until the patient has left the provider's office. In such a situation the targeted messaging does not occur until after the patient has left the provider's office. However, the targeted messaging does occur promptly after the provider submits the claim via EDI. Thus the targeted information is not made available weeks or months after the patient's visit to the provider but instead is provided promptly after the patient's visit.

Thus to briefly outline the process, one embodiment of the process would be as follows.

Provider enters information about the patient visit into the computer.

Information is submitted to the EDI clearinghouse.

Clearinghouse reformats the information if necessary and forwards it to the payer.

The clearinghouse transmits the targeted information to the provider based upon the information content in the provider's submission. Still another example of the invention would be:

Provider enters information about the patient's visit into the computer.

Information is electronically transmitted to the payer

The payer transmits targeted information to the provider based upon the information content in the provider's submission.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, the present invention comprehends that a third party may wish to provide other types of information to the insured besides targeted marketing materials, so long as the claim data meets the predetermined criteria specified by the third party.

What is claimed:

1. A method for employing targeted messaging in connection with delivery of an explanation of benefits to an insured patient being treated by a health care provider comprising the steps of:
(a) providing a claim adjudication program;
(b) inputting claim data to the claim adjudication program through electronic data interchange (EDI) between the health care provider and the payer;
(c) providing substantially immediately targeted messaging materials based on said claim data; and
(d) creating an explanation of benefits (EOB) based upon said claim data.

2. The method of claim 1 wherein the targeted messaging materials are selected based upon the application of predetermined criteria to the claim data.

3. The method of claim 2 wherein the messaging materials are from more than one company if the predetermined criteria selected by said more than one company has been met by said claim data.

4. The method of claim 1 wherein the targeted messaging materials are delivered on a separate page from the EOB permitting the EOB and targeted messaging materials to be delivered selectively to the patient and/or the provider.

5. The method of claim 4 wherein targeted messaging materials are factual medical information to educate the patient and/or the provider.

6. The method of claim 5 wherein it is indicated that the information is sponsored by a particular organization.

7. The method of claim 1 wherein a specific pharmacy advertises its services by providing the targeted messaging in the form of a money-saving coupon when the claim data indicates that the patient has been prescribed a drug as a part of the treatment.

8. The method of claim 1 wherein a payer is an insurance company and wherein the insurance company includes as a part of the targeted messaging materials, other insurance policies that it carries to the patient including life insurance policies and/or long term care policies.

9. The method of claim 7 wherein the claim data is used to indicate in the targeted messaging materials that a different medical insurance policy carried by the same insurance company may be more appropriate for the patient.

10. The method of claim 1 wherein a third party entity who is providing targeted messaging does not receive the EOB or any of the data in the EOB which is kept confidential.

11. A method for employing targeted messaging in connection with delivery of an explanation of benefits statement (EOB) to an insured which comprises the steps of:
(a) providing a claim adjudication program;
(b) examining information provided to the claim adjudication program to see if it meets predetermined criteria; and
(c) sending targeted information if the criteria is met.

12. A method for employing targeted information based on information assembled and submitted in response to an insured patient's visit to a health care provider, comprising the steps of:
(a) inputting claim data to a claim adjudication program through electronic data interchange (EDI) between the health care provider and a payer; and
(b) providing substantially immediately targeted messaging materials based on said claim data.

13. The method of claim 12 wherein the targeted messaging materials are selected based upon the application of predetermined criteria to the claim data.

14. The method of claim 13 wherein the targeted messaging materials are for more than one company if the predetermined criteria selected by said more than one company has been met by said claim data.

15. The method of claim 14 wherein the targeted messaging materials are factual medical information to educate the patient and/or the provider.

16. The method of claim 15 wherein it is indicated that the information is sponsored by a particular organization.

17. The method of claim 12 wherein a specific pharmacy advertises its services by providing the targeted messaging in the form of a money-saving coupon when the claim data indicates the patient has been prescribed a drug as a part of the treatment.

18. The method of claim 12 wherein a payer is an insurance company and wherein the insurance company includes as a part of the targeted messaging materials information regarding other insurance policies that it carries to the patient.

19. The method of claim 18 wherein the claim data is used to indicate in the targeted messaging materials that a different medical insurance policy carried by the same insurance company may be more appropriate for the patient.

20. The method of claim 12 wherein a third party entity who has provided targeted messaging does not receive an EOB or any of the data in the EOB which is kept confidential.

21. The method of claim 18 wherein the information regarding other insurance policies includes information about life insurance policies and/or long term care policies.
